(19) United States
(12) Patent Application Publication
(10) Pub. No.: US 2006/0011022 A1
(43) Pub. Date: Jan. 19, 2006

(54) Hand tool having electrified body detection alarm

(75) Inventors: Stephen Fairburn, Chesterfield (GB); Matthew Arthur Brealy, Chesterfield (GB)

Correspondence Address: BACON & THOMAS, PLLC, 625 SLATERS LANE, FOURTH FLOOR, ALEXANDRIA, VA, 22314, US

(73) Assignee: NEW SUN FAR EAST CORP. LTD., TAICHUNG (TW)

(21) Appl. No.: 10/944,790

(22) Filed: Sep. 21, 2004

(30) Foreign Application Priority Data
Jul. 15, 2004 (TW) 93121213

(51) Int. Cl. B25B 7/00

(52) U.S. Cl. 81/300; 81/900

(57) ABSTRACT

A hand tool includes an alarm circuit assembly mounted in an insulating sheath at a handle of an electrically conducting tool body of the hand tool for producing a visual alarm signal when the electrically conducting tool body of the hand tool touches an electrified body, and a light-transmitting member for reflecting and refracting light from the visual alarm to form a ring of light around a top end of the insulating sheath upon the presence of the visual alarm signal.

### BACKGROUND OF THE INVENTION

1. Field of the Invention

The present invention relates to a hand tool and more particularly, to a hand tool, such as pliers, adjustable wrench, etc., having electrified body detection alarm.

2. Description of the Related Art

When using a cutting tool such as pliers to cut off an electric wire, the worker cannot know the electric status of the electric wire from the outer appearance. If the electric wire is electrified, an electric shock may occur during cutting, thereby resulting in an accident When cutting the electrified electric wire with the cutting tool, a short circuit will be produced, and the high temperature of the short circuit may damage the cutting edges of the blades of the cutting tool and causes a fire. If the electrified electric wire carries a big current, a strong flashlight and big explosion will follow the short circuit, causing an injury to the body of the worker.

Therefore, it is desirable to provide a hand tool that eliminates the aforesaid problems.

### SUMMARY OF THE INVENTION

The present invention has been accomplished under the circumstances in view. It is one object of the present invention to provide a hand tool, which detects the electric status of the workpiece and gives a warning signal when the hand tool touching an electrified body, preventing the accident of an electric shock.

It is another object of the present invention to provide a hand tool, which has the produced warning signal easy to recognize by the user.

To achieve these objects of the present invention, the hand tool comprises a tool body, at least one insulating sheath and an alarm circuit assembly. The tool body is made of electrically conducting material and has a handle and a work head. The insulating sheath is made of electrically insulating material and is covered on the handle of the tool body. Each the insulating sheath has a longitudinal receiving hole for receiving the handle. The alarm circuit assembly comprises a circuit board mounted inside the insulating sheath for detecting electric status of the tool body, a battery set mounted inside the insulating sheath for providing electricity to the circuit board, and an alarm electrically connected to the battery set through the circuit board and controlled by the circuit board to produce an alarm signal upon detection of the presence of electric current at the tool body by the circuit board.

### BRIEF DESCRIPTION OF THE DRAWINGS

FIG. 1 is an exploded view of a hand tool according to the first preferred embodiment of the present invention.

FIG. 2 illustrates the insulating sheaths respectively fastened to the handles of the rod elements of the tool body according to the first preferred embodiment of the present invention.

FIG. 3 is a front view of the hand tool according to the first preferred embodiment of the present invention.

FIG. 4 is a left side view of the hand tool according to the first preferred embodiment of the present invention.

FIG. 5 is a perspective view of a hand tool according to the second preferred embodiment of the present invention.

### DETAILED DESCRIPTION OF THE INVENTION

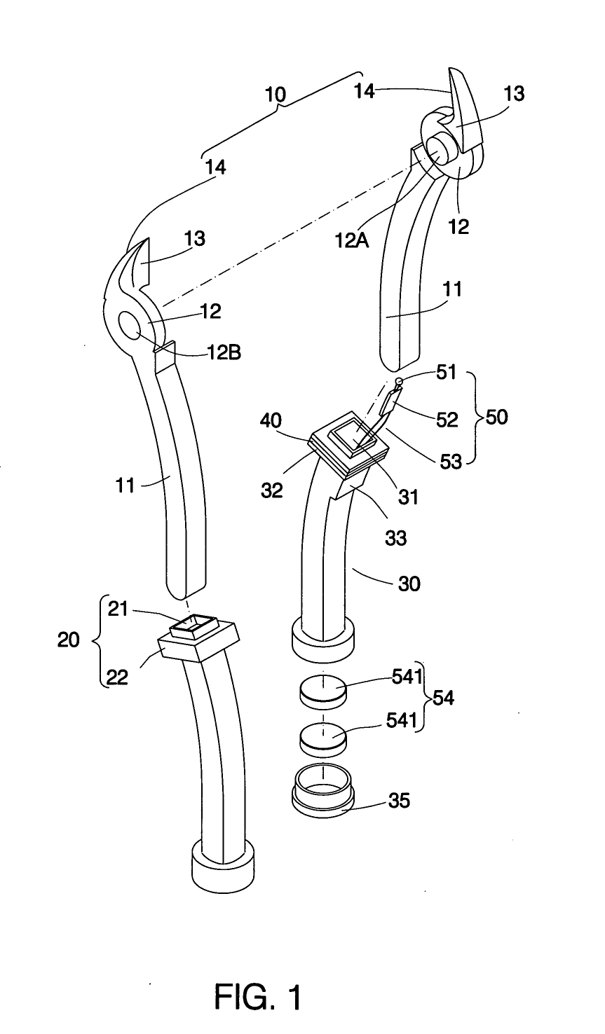

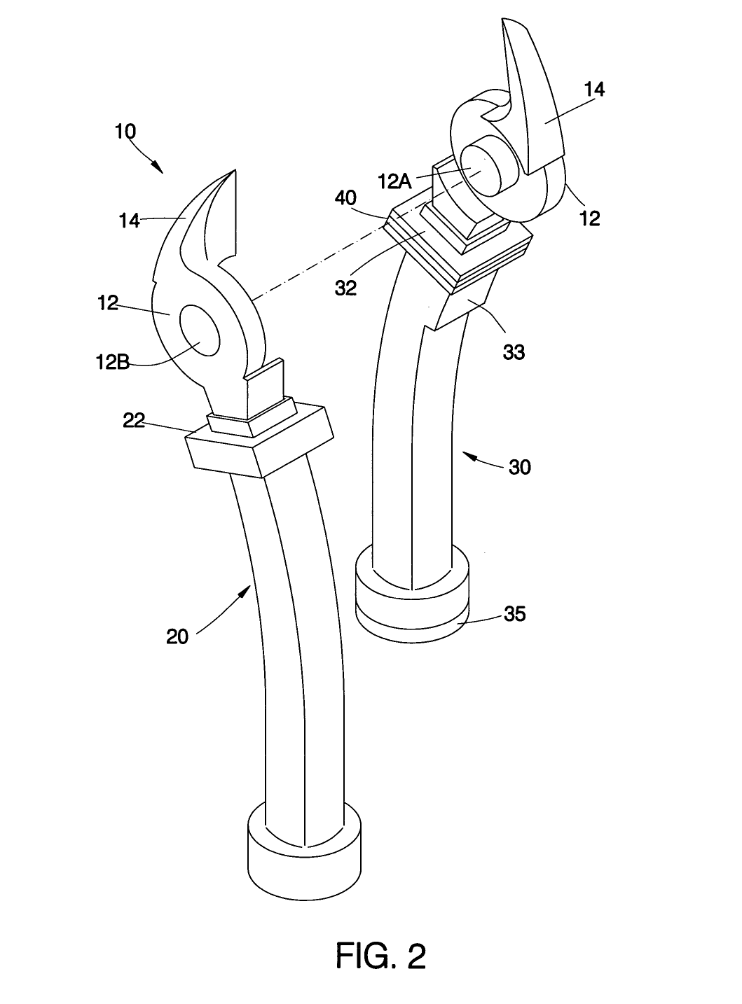

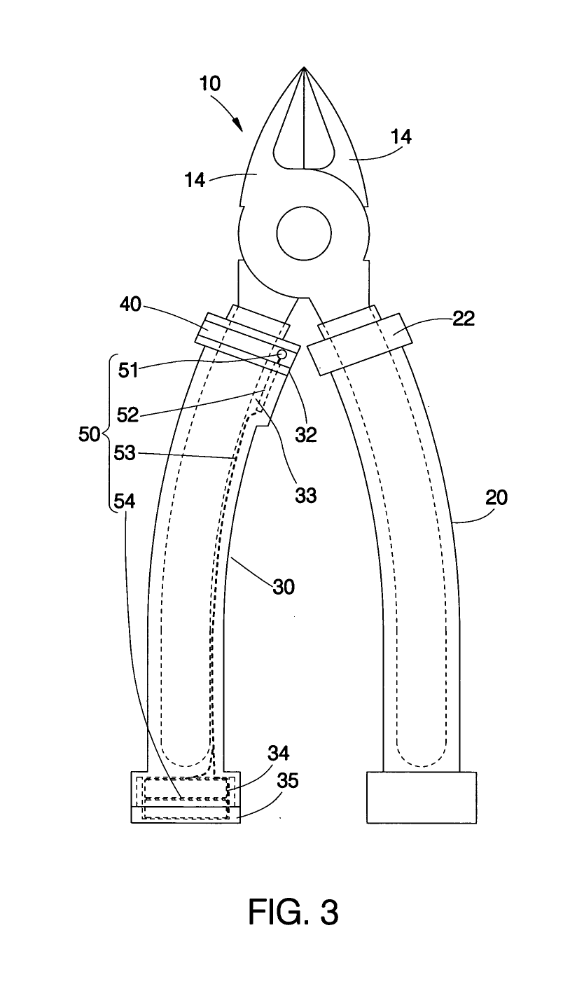

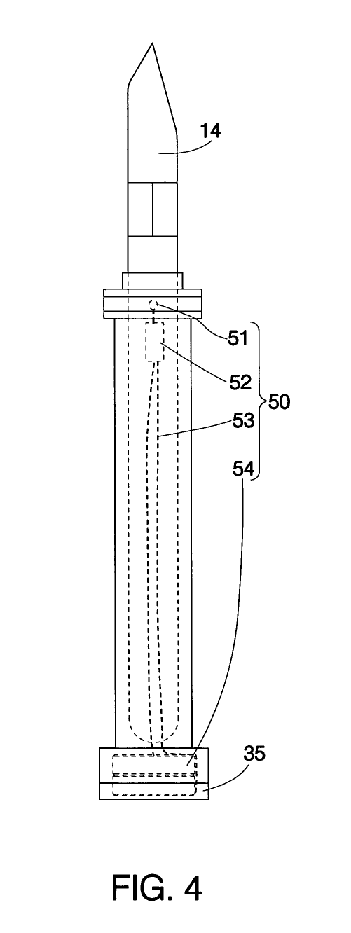

Referring to FIGS. 1-4, a hand tool having electrified body detection alarm in accordance with the first preferred embodiment of the present invention is shown comprised of a tool body 10, two insulating sheaths 20, 30, a light-transmitting member 40, and an alarm circuit assembly 50.

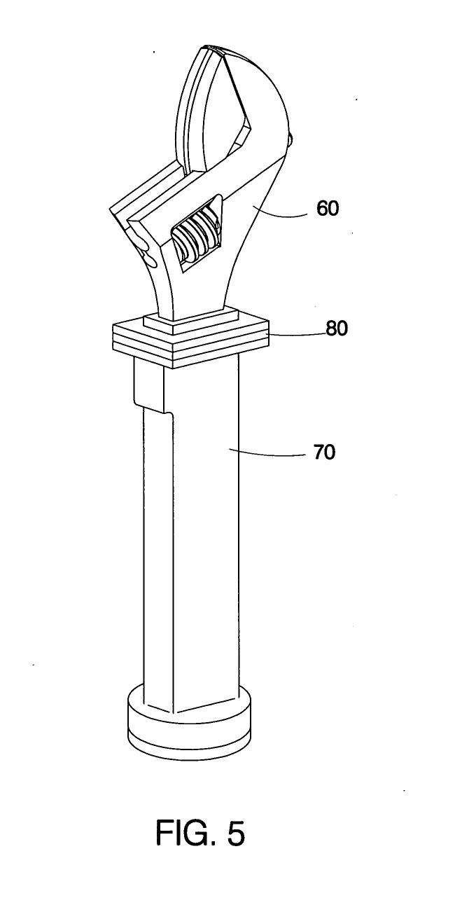

The tool body 10 is made of an electrically conducting metal material and comprised of two rod elements 14 in mirror symmetry. The rod elements 14 each have a handle 11 at one end, a work head 13, which is a blade in this embodiment and can be a jaw as shown in FIG. 5, at the other end, and a coupling portion 12 connected between the handle 11 and the work head 13. The coupling portion 12 of one of the rod elements 14 comprises a pivot pin 12A. The coupling portion 12 of the other of the rod elements 14 comprises a pivot hole 12B, which receives the pivot pin 12A. After connection between the pivot pin 12A and the pivot hole 12B, the two rod elements 14 can be operated to make a scissors action, thereby causing the work heads 13 to grasp or cut the workpiece.

The two insulating sheaths 20, 30 are respectively molded from electrically insulating material. The first insulating sheath 20 has a longitudinal receiving hole 21 longitudinally extended to one end thereof for receiving the handle 11 of one rod element 14, and a finger flange 22 extended around the outer open end of the longitudinal receiving hole 21 for stopping the fingers of the user's hand holding the first insulating sheath 20 from touching the unsheltered rod elements 14 accidentally. The second insulating sheath 30 has a longitudinal receiving hole 31 longitudinally extended to one end thereof for receiving the handle 11 of the other rod element 14, a finger flange 32 extended around the outer open end of the longitudinal receiving hole 21 for stopping the fingers of the user's hand holding the second insulating sheath 30 from touching the unsheltered rod elements 14 accidentally, a first chamber 33 disposed adjacent to the outer open end of the longitudinal receiving hole 21, and a second chamber 34 formed in the rear end sealed with an end cap 35. The light-transmitting member 40 is a transparent hollow endless member molded from acrylics or the like that admits light, and fastened to the periphery of the finger flange 32 of the second insulating sheath 30 around the top open end of the longitudinal receiving hole 31. It is to be understood that the light-transmitting member 40 can be transparent, or have a particular color that attracts attention.

The alarm circuit assembly 50 comprises an alarm 51, a circuit board 52, electric wires 53, and a battery set 54. According to this embodiment, the alarm 51 is a visual alarm formed of a light emitting diode and mounted inside the second insulating sheath 30 corresponding to the light-transmitting member 40. The circuit board 52 is mounted inside the first chamber 33 and electrically connected with the alarm 51, having an electronic loop adapted to detect the electric status of the tool body 10 and to control on/off of the alarm 51 subject to the electric status of the tool body 10. The battery set 54 is comprised of a series of battery cells 541 mounted inside the second chamber 34 and electrically connected to the circuit board 52 by the electric wires 53.

After understanding of the structural features of the hand tool, the operation of the hand tool will now be described hereinafter. During operation, the user holds the sheaths 20, 30 with the hands to move the handles 11 of the rod elements 14 relative to each other and to further close/open the work heads (blades or jaws) 13 of the rod elements 14. When the work heads (blades or jaws) 13 touch an electrified body, for example, an electrified electric wire, the electronic loop of the circuit board 52 of the alarm circuit assembly 50 is induced to drive the visual alarm 51, thereby causing the alarm 51 to produce a visual alarm signal, for example, red light through the light-transmitting member 40. Upon presence of the visual alarm signal, the user can immediately stop working, preventing a short circuit to damage the work heads (blades or jaws) 13. After power supply has been cut off from the workpiece, the user can then proceed with the cutting operation safely. Further, the sheaths 20, 30 isolate electric current when the rod elements 14 touch an electrified body, preventing the user from suffering an electric shock accidentally. Further, because the light-transmitting member 40 is a hollow endless member molded from acrylics or the like that admits light, and fastened to the periphery of the finger flange 32 of the second insulating sheath 30 around the top open end of the longitudinal receiving hole 31, it reflects and refracts light from the alarm 51 in different angles. Therefore, the user can see the light of the alarm 51 from any angle. Further, as an alternate form of the alarm circuit assembly 50, the alarm 51 can be an audio alarm formed of a buzzer, so that the light-transmitting member can be eliminated.

FIG. 5 shows a hand tool, i.e. adjustable wrench, having electrified body detection alarm in accordance with the second embodiment of the present invention. According to this embodiment, the hand tool is comprised of a tool body 60, an insulating sheath 70, a light-transmitting member 80, and an alarm circuit assembly (not shown). This embodiment is substantially similar to the aforesaid first embodiment of the present invention with the exception that the tool body 60 has only one single handle, and one single sheath 70 is used and covered on the handle of the tool body 60.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A hand tool comprising a tool body, at least one insulating sheath, and an alarm circuit assembly;
wherein said tool body is made of electrically conducting material and has a handle and a work head;
wherein said insulating sheath is made of electrically insulating material and has a longitudinal receiving hole for receiving the handle of said tool body;
wherein said alarm circuit assembly comprises a circuit board mounted inside said insulating sheath for detecting electric status of said tool body, a battery set mounted inside said insulating sheath for providing electricity to said circuit board, and an alarm electrically connected to said circuit board and controlled by said circuit board to produce an alarm signal upon detection of the presence of electric current at said tool body by said circuit board.

2. The hand tool as claimed in claim 1, wherein said tool body comprises two rod elements in mirror symmetry, said rod elements each having at one end thereof said handle onto which said insulating sheath is sleeved, said work head at an opposite end, and a coupling portion connected between said handle and said work head, the coupling portions of said rod elements being pivotally coupled to each other.

3. The hand tool as claimed in claim 2, wherein said alarm is an audio alarm.

4. The hand tool as claimed in claim 2, wherein said alarm is a visual alarm.

5. The hand tool as claimed in claim 4, further comprising an endless light-transmitting member mounted in one said insulating sheath around said visual alarm for reflecting and refracting light from said visual alarm.

6. The hand tool as claimed in claim 5, wherein said visual alarm and said endless light-transmitting member are set at the same elevation.

7. The hand tool as claimed in claim 6, wherein each said insulating sheath comprises a finger flange extended around an outer open end of the respective longitudinal receiving hole; said endless light-transmitting member is mounted in the finger flange of one said insulating sheath.

8. The hand tool as claimed in claim 1, wherein said insulating sheath comprises a first chamber formed in a first end thereof at one side of an outer open end of the longitudinal receiving hole thereof for accommodating said circuit board, a second chamber formed in a second end thereof for accommodating said battery set, and an end cap for closing said second chamber.

9. The hand tool as claimed in claim 7, wherein said insulating sheath comprises a first chamber formed in a first end thereof at one side of the outer open end of the longitudinal receiving hole thereof for accommodating said circuit board, a second chamber formed in a second end thereof for accommodating said battery set, and an end cap for closing said second chamber.

10. The hand tool as claimed in claim 5, wherein said light-transmitting member is molded from acrylics.

11. The hand tool as claimed in claim 1, wherein said alarm is an audio alarm.

12. A hand tool comprising a tool body, at least one insulating sheath, and an alarm circuit assembly;
wherein said tool body is made of electrically conducting material and has a handle and a work head;
wherein said insulating sheath is made of electrically insulating material and covered on the handle of said tool body;
wherein said alarm circuit assembly comprises a circuit board mounted inside said insulating sheath for detecting electric status of said tool body, a battery set mounted inside said insulating sheath for providing electricity to said circuit board, and a visual alarm mounted in a top end of said insulating sheath and electrically connected to said circuit board and controlled by said circuit board to produce a visual alarm signal upon detection of the presence of electric current at said tool body by said circuit board.

13. The hand tool as claimed in claim 12, further comprising an endless light-transmitting member mounted in said insulating sheath around said visual alarm for reflecting and refracting light from said visual alarm to produce a ring of light.
